(19) United States
(12) Patent Application Publication
(10) Pub. No.: US 2018/0321370 A1
(43) Pub. Date: Nov. 8, 2018

(54) Method for controlling message transmission power implemented by a system for preventing collisions of aircraft during flight

(71) Applicant: Airbus Operations SAS, Toulouse (FR)

(72) Inventor: Jean-Luc ROBIN, Saint Jean (FR)

(21) Appl. No.: 15/774,874

(22) PCT Filed: Nov. 8, 2016
(86) PCT No.: PCT/EP2016/076964

§ 371 Date: May 9, 2018

(30) Foreign Application Priority Data
Nov. 13, 2015 (FR) 1560886

(51) Int. Cl. G01S 13/78; G08G 5/00; G08G 5/04; G01S 7/02; G01S 13/93

(52) U.S. Cl. CPC G01S 13/781; G08G 5/0008; G08G 5/0021; G01S 2007/4013; G08G 5/0078; G01S 7/023; G01S 13/9303; G08G 5/045

(57) ABSTRACT

A method and system for controlling message transmission power implemented by a system for preventing collisions of aircraft during flight, the prevention system comprising an anti-collision device and a transponder with which each plane is equipped. There is a step for measuring at least the quality value of a quantity representative of the quality at which radio-frequency signals carrying response messages transmitted by a transponder of an intruding aircraft are received, and a step for controlling the power of transmission of the radio-frequency signals carrying the response messages depending o the quality value or values measured in this way.

### CROSS-REFERENCES TO RELATED APPLICATIONS

This application claims the benefit of the French patent application No. 1560886 filed on Nov. 13, 2015, the entire disclosures of which are incorporated herein by way of reference.

### BACKGROUND OF THE INVENTION

The present invention concerns a method of controlling message transmission power implemented by a system for preventing collisions of aircraft during flight, as well as a system of that type for preventing collisions of aircraft.

The field of the present invention is that of systems for preventing collisions of aircraft during flight and, more particularly, a known system known as TCAS (Traffic Alert and Collision Avoidance System). A system of this kind can operate in a plurality of modes, in particular, a so-called C/A mode and an S mode. The present invention is adapted to the operation of the system in its S mode.

Purely for convenience, a system of this kind is termed an anti-collision system in the present description. Any aircraft that uses an anti-collision system of this kind is equipped, on the one hand, with a so-called TCAS device the name of which is generally confounded with that of the system and which in the present description is termed, also for convenience, an anti-collision apparatus, and, on the other hand, a transponder, which can be used for other functions that are not directly related to the present invention and for that reason are not described.

The operation of an anti-collision system of this kind in the aforementioned S mode is illustrated in FIG. 1. Any aircraft in flight emits at regular intervals so-called “squitter” beacon signals Sq containing, in particular, an address of the transmitting aircraft. If the anti-collision apparatus of an aircraft 1 receives a signal Sq of this kind from another aircraft 2 also in flight, it transmits a request message Req to the aircraft 2. On receiving this message Req, the transponder of the aircraft 2 transmits a response Rep which, when received by the anti-collision apparatus of the aircraft 1, is used by the device to determine the distance (termed Range) separating the aircraft 1 from the aircraft 2, the relative speed (Range rate) between the two aircraft, the estimated time (Tau) before a possible collision, and the angle (Bearing) between the bearing of the aircraft 1 and the direction of the aircraft 2, etc. On the basis of the content of this response, the anti-collision apparatus of the aircraft 1 decides whether or not to follow this preliminary surveillance phase with a phase of tracking the aircraft 2 that is now referred to as an “intruder”. If this is the case, request messages Req are transmitted at regular time intervals by the aircraft 1 to the intruder aircraft 2, to which the latter responds with response messages Rep. The responses provided by the intruder aircraft 2 enable the anti-collision apparatus of the aircraft 1 to predict a possible collision and most importantly to transmit alerts such as Traffic Advisories (TA) and/or Resolution Advisories (RA).

To transmit their respective messages, in particular the messages Req and Rep, the anti-collision apparatus and the transponders of a TCAS anti-collision system use frequency bands of 1030 MHz and 1090 MHz respectively. The transponders are used, as well as by the TCAS anti-collision system, by the secondary surveillance radar (SSR) system to respond to requests from the latter in accordance with the same mechanism as is used for the TCAS anti-collision system. Moreover, the DME (distance measuring equipment) signals are also transmitted in the same frequency bands. The various uses of those frequency bands can cause interference between radiofrequency signals interfering with the operation of all these systems. Moreover, the increased aircraft traffic density and the increased quantity of information transmitted by these various systems have the effect of increasing the congestion of the frequency bands referred to above, which causes interference between radiofrequency signals transmitted in the frequency bands mentioned above more and more frequently, and so one of the problems arising from TCAS anti-collision systems is that of reducing such interference as much as possible.

To this end, two known methods are proposed by the DO-185B MOPS (Minimum Operational Performance Standards) standard relating to systems for avoiding collisions and TCAS traffic alerts. Both consist in controlling the transmission power of the request messages Req from the anti-collision apparatus of one aircraft to the transponder of the other aircraft, in particular during the tracking phase mentioned above. According to one method, termed power programming in the DO-185B standard, these messages are transmitted at a transmission power P reduced relative to a predetermined maximum power Pmax by an amount increasing according to the increasing closeness of the other aircraft concerned.

According to the second method recommended by the DO-185B standard, termed interference limiting, the transmission power of the request messages is a function only of the number of aircraft around the aircraft concerned.

Although these methods are satisfactory at present, if aircraft traffic density and the quantity of information to be transmitted increase, they may prove insufficient to solve the interference problems referred to above. Other measures are therefore required.

### SUMMARY OF THE INVENTION

An object of the present invention is therefore to propose a method of controlling the transmission power of messages used by a system for preventing collisions of aircraft during flight, the system being of the type including an anti-collision apparatus and a transponder equipping each aircraft, the method including the following steps carried out by the anti-collision apparatus of a first aircraft:

a step of transmission of request messages in the form of radiofrequency signals carrying the messages, and

a step of reception of radiofrequency signals carrying response messages transmitted by the transponder in response to the request messages,

the method further including the following steps carried out by the transponder of a second aircraft:

a step of reception of the radiofrequency signals carrying request messages transmitted by the anti-collision apparatus, and

a step of transmission of the radiofrequency signals carrying response messages in response to request messages.

According to the invention, the method further includes the following steps carried out by the anti-collision apparatus of the first aircraft:

a measurement step for measuring at least the value, termed the quality value, of a magnitude representing the quality of reception of the radiofrequency signals carrying response messages transmitted by the transponder and a step of encapsulation of data representing the quality value or values in the request message to be transmitted by the anti-collision apparatus.

According to one aspect of the present invention, the method further includes the following steps carried out by the transponder of the second aircraft:

a control step for controlling the transmission power of the radiofrequency signals carrying the response messages as a function of the quality value or values encapsulated in the request messages transmitted by the anti-collision apparatus of the first aircraft.

### BRIEF DESCRIPTION OF THE DRAWINGS

The features of the invention mentioned above, and others, will become more clearly apparent on reading the following description of one embodiment, the description being given with reference to the appended drawings, in which:

FIG. 1 is a view illustrating the operation of an anti-collision system,

FIG. 2 is a block diagram of an anti-collision system according to a first embodiment of the present invention, including an anti-collision apparatus and a transponder,

FIG. 3A is a diagram illustrating the steps that are carried out by an anti-collision apparatus of an anti-collision system according to the present invention,

FIG. 3B is a diagram illustrating the steps that are carried out by a transponder of an anti-collision system in accordance with one embodiment of the present inventor,

FIG. 3Bbis is a diagram illustrating the steps that are carried out by a transponder of an anti-collision system according to another embodiment of the present invention,

FIG. 4 is a block diagram of an anti-collision system according to a second embodiment of the present invention, and

FIGS. 5A and 5B are diagrams illustrating the steps that are respectively carried out by an anti-collision apparatus and a transponder of an anti-collision system according to the FIG. 4 embodiment.

### DETAILED DESCRIPTION OF THE PREFERRED EMBODIMENTS

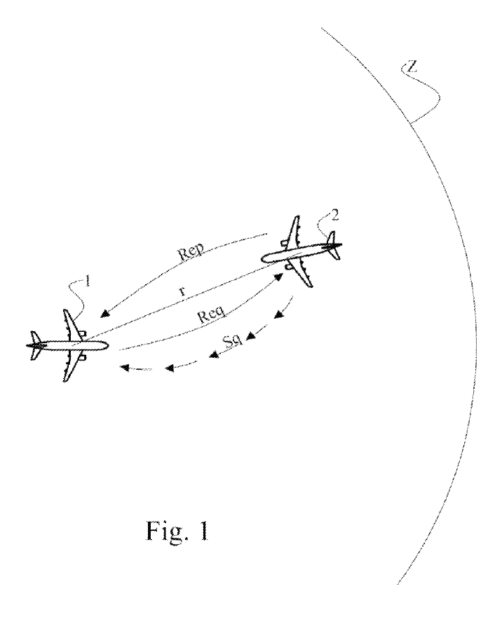

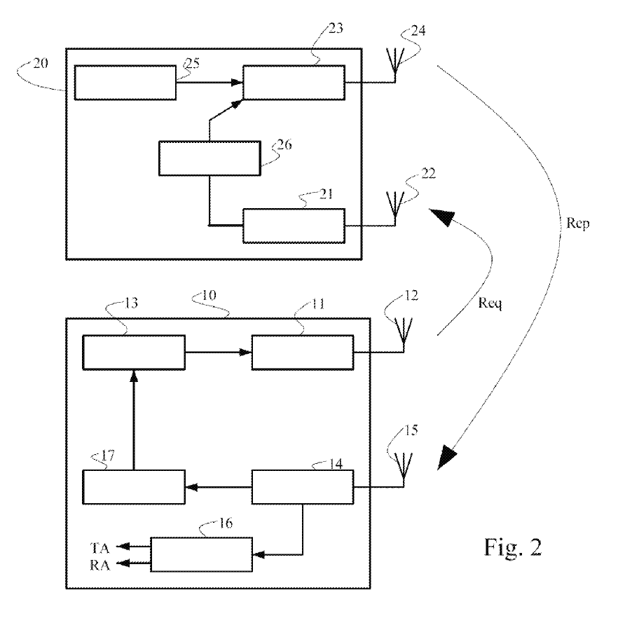

There is represented in FIG. 2 a system according to the present invention for preventing aircraft collisions, referred to herein as an anti-collision system, for example of the TCAS type, which includes, on the one hand, an anti-collision apparatus 10 that equips a first aircraft such as the aircraft 1 from FIG. 1 and, on the other hand, a transponder 20 that equips a second aircraft such as the intruder aircraft 2 from FIG. 1. In FIG. 2, the anti-collision apparatus 10 and the transponder 20 are in communication with one another. It will be clear that any aircraft generally includes both an anti-collision system and a transponder 20.

The anti-collision apparatus 10 essentially includes a transmission system 11 with its antenna 12 which are intended to transmit radiofrequency signals carrying request messages Req that are supplied to it by a unit 13 for generating such messages. It also includes a receiver 14 with its antenna 15 that are intended to receive the radiofrequency signals carrying response messages Rep transmitted by a transponder 20 of another aircraft (termed an intruder aircraft) in response to request messages Req previously transmitted by the anti-collision apparatus 10. The receiver 14 is connected to a unit 16 for analyzing response messages Rep intended to deliver, as is known in itself, Traffic Advisories (TA) or Resolution Advisories (RA).

As for the transponder 20, it essentially includes a reception system 21 with its antenna 22 for receiving the radiofrequency signals transmitted by the transmission system 11 of an anti-collision apparatus 10 and recovering the request messages Req that the received radiofrequency signals carry. It also includes a transmission system 23 and an antenna 24 for transmitting radiofrequency signals carrying response messages Rep to the anti-collision apparatus 10 that transmitted the request message Req received by the reception system 21. The response messages Rep are generated by a generator unit 25.

For example, the radiofrequency signals transmitted by the transmission system 11 have a frequency of 1030 MHz while those transmitted by the transmission system 23 have a frequency 1090 MHz.

According to the present invention, an anti-collision apparatus 10 further includes a unit 17 for measuring the quality Q of the radiofrequency signals received by the reception system 14. This measurement unit 17 delivers data relating to the measured quality value or values Q and supplies these data to the unit 13 for generating request messages Req in order for it to encapsulate them in these messages Req.

As for the transponder 20, it further includes a decapsulation unit 26 for recovering the data relating to the quality value or values Q measured by the measurement unit 17 of the anti-collision apparatus 10 and transmitted by the anti-collision apparatus 10 by means of messages Req and controlling the transmission system 23 in order to control its transmission power Pt.

Accordingly, via its transmission system 11, the anti-collision apparatus 10 transmits radiofrequency signals carrying a request message Req to a transponder 20, which receives these radiofrequency signals via its reception system 21 and then, by means of its generator unit 25, generates a response message Rep. This response message Rep is transmitted by the transmission system 23 in the form of radiofrequency signals to the anti-collision apparatus 10. The latter receives these radiofrequency signals via its receiver 14 and measures the quality value or values Q by means of its measurement unit 17. The quality value or values Q measured in this way are encapsulated in the form of data in the request message Req generated by the generator unit 13 and supplied to the transmission system 11. The latter transmits radiofrequency signals carrying this request message Req to the transponder 20 for which a response message Rep has previously been received.

On reception by the reception system 21 of this request message Req, the decapsulation unit 26 decapsulates the data contained in the request message Req received and extracts therefrom the measured quality value or values Q represented by that data. The or each measured quality value Q is supplied to the transmission system 23 of the transponder 20 for adjustment of the transmission power Pt of the next response message Rep.

To be more precise, if the or each quality value measured by the measurement unit 17 represents a low quality, i.e., one lower than one or more quality threshold values, the decapsulation unit 26 commands the transmission system 23 to increase its transmission power Pt relative to the preceding transmission, for example by a predetermined incremental value, or a value that is a function of the measured quality value or values or a value that is a function of the difference between the measured value or values and one or more threshold values. Conversely, if the or each quality value measured by the measurement unit 17 represents a high quality, i.e., one greater than one or more quality threshold values, the decapsulation unit 26 commands the transmission system 23 to reduce its transmission power Pt relative to the preceding transmission, for example by a predetermined decremental value, a value that is a function of the measured quality value or values, or a value that is a function of the difference between the measured value or values and one or more threshold values.

According to one embodiment, the quality value of the radiofrequency signal measured by the measurement unit 17 is the value of at least one of the following characteristics:

the reception power Pr of the radiofrequency signals carrying a response message Rep transmitted by the transponder 20 and received via the reception system 14,

the signal-to-noise ratio S/N of the radiofrequency signal carrying a response message Rep transmitted by the transponder 20 and received via the reception system 14,

the bit error rate (BER) of the radiofrequency signal carrying a response message Rep transmitted by the transponder 20 and received via the reception system 14.

According to one particular embodiment of the invention, the quality of the radiofrequency signal measured by the measurement unit 17 is therefore the reception power Pr of the radiofrequency signals carrying a response message Rep received via the reception system 14. Accordingly, if the measured value of the reception power Pr is less than a power threshold value Ps, the transmission power Pt of the transmission system 23 is increased, for example by a predetermined incremental value, a value that is a function of the measured reception power Pr or a value that is a function of the difference Pr−Ps. Conversely, if the measured value of the reception power Pr is greater than a power threshold Ps, the transmission power Pt of the transmission system 23 is reduced, for example by a predetermined decremental value, a value that is a function of the measured reception power Pr or a value that is a function of the difference Pr−Ps.

According to another particular embodiment of the invention, the quality of the radiofrequency signal measured by the measurement unit 17 is the signal-to-noise ratio S/N of the radiofrequency signal carrying a response message Rep received via the reception system 14. Accordingly, if the measured value of the ratio S/N is less than a threshold value S/Ns, the transmission power Pt of the transmission system 23 is increased and conversely, if the measured value is greater than the threshold value S/Ns, the signal transmission power Pt is reduced.

According to a further embodiment of the invention, the quality of the radiofrequency signal measured by the measurement unit 17 is the bit error rate (BER) of the radiofrequency signal carrying a response message Rep as received and decoded by the reception system 14. Accordingly, if the measured value of the bit error rate is less than a threshold value BERs, the transmission power Pt of the transmission system 23 is reduced and conversely, if the measured value is greater than the threshold value BERs, the transmission power Pt of the transmission system 23 is increased.

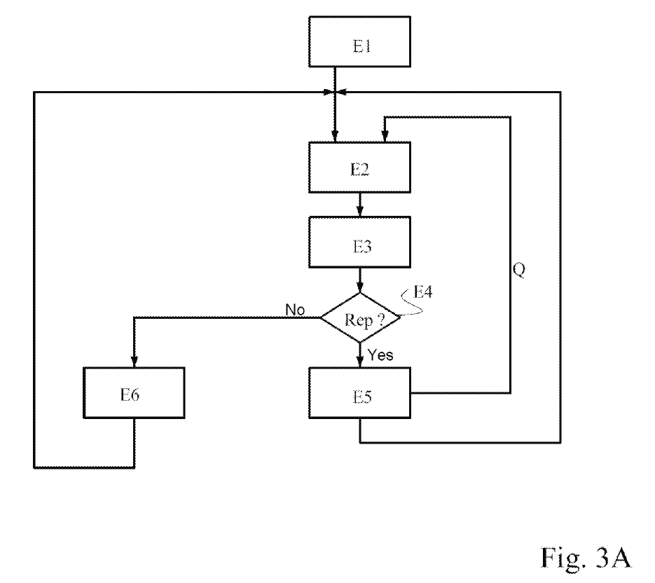

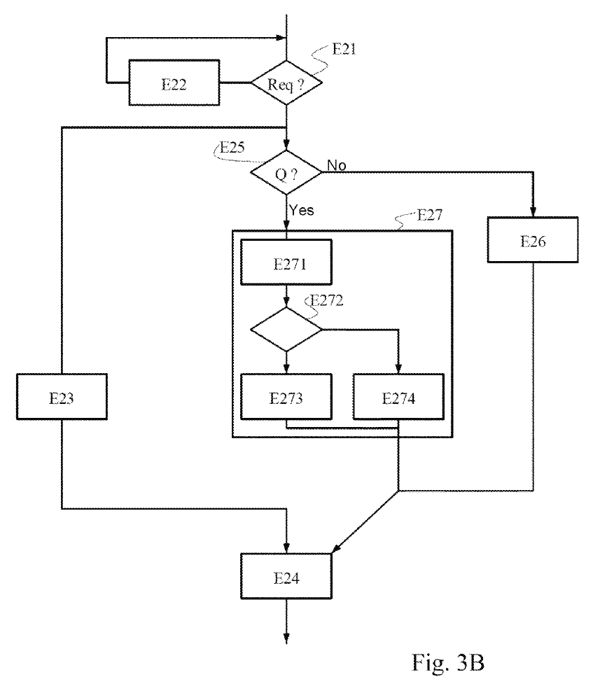

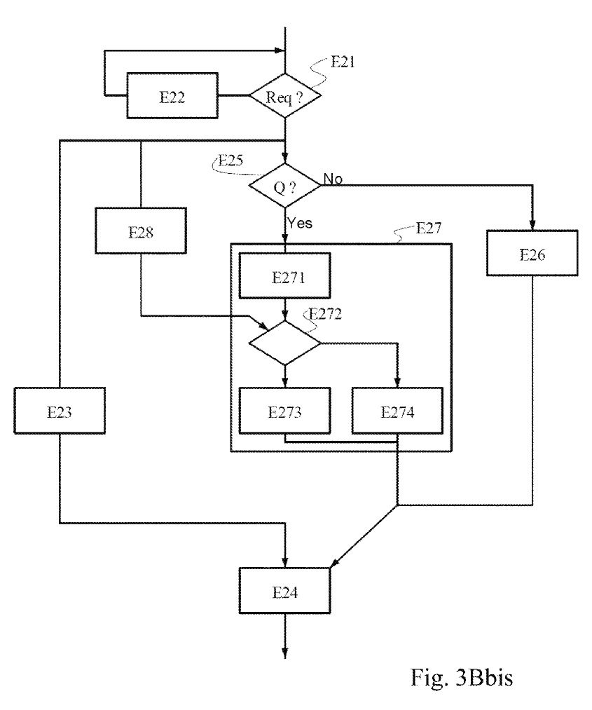

FIG. 3A is a diagram illustrating the power control method in accordance with the invention that is implemented by an anti-collision apparatus 10 of an aircraft, such as the aircraft 1 from FIG. 1.

The step E1 is a step of triggering tracking of an intruder aircraft, such as the aircraft 2 from FIG. 1. For example, this step E1 follows on from reception by the anti-collision apparatus 10 of a squitter beacon signal Sq transmitted by the aircraft 2 and the decision to consider that aircraft 2 as an intruder aircraft to be tracked. This beacon signal Sq further contains the address of the transponder 20 of the aircraft 2.

This step E1 can trigger a number of processes simultaneously, such as the power control method of the invention but also trajectory study processes leading to the transmission of Traffic Advisories (TA) and/or Resolution Advisories (RA). Only the process in accordance with the present invention of controlling the transmission power of response messages to requests is described here.

It will be clear that all the steps of the power control method of the present invention form one instance of a method of controlling the transmission power Pt of the response messages Rep transmitted by an intruder aircraft 2 and that there are as many instances implemented by an anti-collision apparatus 10 at a given time as there are intruder aircraft at that time.

The step E2 is a step of generation of a request message Req to the transponder 20, for example by the generator unit 13 of the anti-collision apparatus 10.

The step E3 is a step of transmission at a transmission power Pe of radiofrequency signals carrying the request message Req generated in the step E2, for example by the transmission system 11 of the anti-collision apparatus 10.

The transmission power Pe of a message Req by the transmission system 11 conforms for example to the power programming method of the DO-185B standard and is therefore equal to a power Pe increasingly reduced relative to a predetermined maximum power Pemax the closer is the intruder aircraft 2 to the aircraft 1 concerned. This transmission power Pe is expressed in accordance with the following formula:

Pe=Pemax+20 log(r/10),

in which r is the distance (also termed the range), expressed in nautical miles, between the aircraft 1 concerned and the intruder aircraft 2. The power Pemax is for example 250 watts. This formula is applied only if the distance (range) r is less than 10 nautical miles.

The step E4 is a step of reception of a response message Rep responding to a request message Req transmitted previously.

If in the step E4 a response message Rep transmitted by a transponder 20 has actually been received (option “yes”), there is carried out a step E5 of measuring the quality of the radiofrequency signals received, from which result(s) one or more quality values Q supplied to the generator step E2 to be included or not in the message Req generated in the step E2 and transmitted in the step E3.

Following the step E5, there are carried out again a step E2 of generating a response message Rep and a step E3 of transmitting a message Rep of this kind.

If in the step E4 no response has been received from the transponder 20 to a request message Req previously transmitted by the anti-collision apparatus 10 (option “no”), for example at the end of a predetermined time, there is carried out a step E6 of resetting the transmission power Pe to a value greater than the current value, for example to the maximum power Pemax.

This step E6 enables solution of the problem linked to the fact that an absence of response from the transponder 20 can be the result of deterioration of the transmission conditions between the aircraft 1 and the aircraft 2. Increasing the transmission power Pe to a value greater than the current power value, or even up to the maximum power Pemax, enables compensation of this deterioration and offers increased safety by favoring the re-establishing of contact with the intruder aircraft 2.

FIG. 3B is a diagram of the steps of the method of the invention that are carried out in a transponder 20 of an aircraft such as the aircraft 2 from FIG. 1 when it is considered an intruder aircraft by an aircraft 1.

The step E21 is a step of receiving radiofrequency signals carrying a request message Req transmitted by an anti-collision apparatus 10 of another aircraft, such as the aircraft 1 from FIG. 1. This step E21 is, for example, carried out by the reception system 21 of a transponder 20.

The step E22 is a step of setting the transmission power Pt to a value higher than the current value, for example to a maximum value Ptmax that is used if the reception step E21 does not receive any request message Req from an anti-collision apparatus 10 during a predetermined time.

If a request message Req has actually been received in the reception step E21, then there are carried out a step E23 that is a step of generating a response message Rep (carried out for example by the generator unit 25) and a step E24 that is a step of transmission in the form of radiofrequency signals of the response message Rep resulting from the step E23 (this step E24 is, for example, carried out by a transmission system 23 of a transponder 20).

The step E25 is a step of verification that the message Req that was received in the step E21 contains data relating to the quality Q of the radiofrequency signals carrying a request message Req previously transmitted by the anti-collision apparatus 10 and received by the transponder 20. If this is not the case (option “no”), there is carried out a step E26 of setting the transmission power Pt of the next response message Rep to be transmitted in the step E24 to a maximum transmission power Ptmax, for example 250 watts. The control step E26 controls the transmission power Pt of the transmission step E24.

This loop via the verification step E25 and the control step E26 enables compatibility of the anti-collision system of the invention in the situation where the anti-collision apparatus 10 that has transmitted a request message Req is in accordance with the prior art and therefore does not implement the power control method according to the present invention (the messages Rep do not encapsulate quality data Q).

If the message Req read in the step E21 and verified in the step E25 contains data relating to the quality Q of the radiofrequency signals received by the anti-collision apparatus 10 and measured by its measurement unit 17 (option “yes”), there is carried out (for example by the decapsulation unit 26 from FIG. 2) a control step E27 for setting the transmission power Pt of the radiofrequency signals carrying the response messages Rep as a function of the quality value or values encapsulated in the request messages Req transmitted by the anti-collision apparatus 10.

In the embodiment shown, the control step E27 includes a step E271 of extraction of the quality data Q (carried out, for example, by the encapsulation unit 26 of the transponder 20) followed by a step E272 of comparison of the value or values relating to that quality value Q to one or more threshold values St. For example, this or each threshold value St is a predetermined value.

In the step E272, if the quality represented by the quality data Q is below the quality represented by this threshold value or values St, there is carried out a step E273 of increasing the transmission power Pt of the next response message Rep to be transmitted and, conversely, if it is above the quality represented by this threshold value or values St, there is carried out a step E274 of reducing the transmission power Pt of the next response message Rep to be transmitted.

Both steps E273 and E274 control the transmission power Pt of the transmission step E24.

FIG. 3Bbis is a diagram of the steps of a variant of the FIG. 3 method that are carried out in a transponder 20 of an aircraft when it is considered by an aircraft 1 as an intruder aircraft, such as the aircraft 2 from FIG. 1. This method differs from that described with reference to FIG. 3B in that it further includes a step E28 of adjustment of the or each threshold value St that is then taken into account in the control step E27, and in particular, in the embodiment shown, in the comparison step E272.

The step E28 adjusts the or each threshold value St dynamically, for example on the basis of aeronautical parameters. Also, this adjustment is applied for each intruder aircraft.

For example, the step E28 dynamically adjusts the or each value of the threshold St as a function of the nature of the request messages Req received that may come from an anti-collision apparatus 10 of another aircraft (the message Req is of the type UF=0 or UF=16; UF=Uplink Format) or come from a secondary surveillance radar (SSR) system (the message Req is then of the type UF=4, UF=20 or UF=21). For example, the lower the frequency of reception of the messages Req coming from an anti-collision apparatus 10, which means that the relative position of the two aircraft is refreshed less often, the higher the value of the threshold St to prevent too great an impact following a loss of data.

Again for example, if a message analysis unit 16 of an anti-collision apparatus 10 has transmitted a Traffic Advisory TA or a Resolution Advisory RA and that Traffic Advisory TA or Resolution Advisory RA is still active, the threshold value St is adjusted upward by the step E28. This anti-collision apparatus 10 may be that of the aircraft 1 from FIG. 1, but equally the anti-collision apparatus 10 of the aircraft 2. In the former case, the Traffic Advisory TA or Resolution Advisory RA is transmitted from the anti-collision apparatus 10 of the aircraft 1 by means of an appropriate message (UF=16). In the latter case, the Traffic Advisory TA or Resolution Advisory RA transmitted by the anti-collision apparatus 10 of the aircraft 2 is passed to the transponder 20 of the same aircraft 2 (this procedure is covered by the ARINC 735B standard).

Again for example, the or each threshold value St can be adjusted as a function of the altitude of the aircraft 2, to be more precise adjusted upward if the altitude decreases.

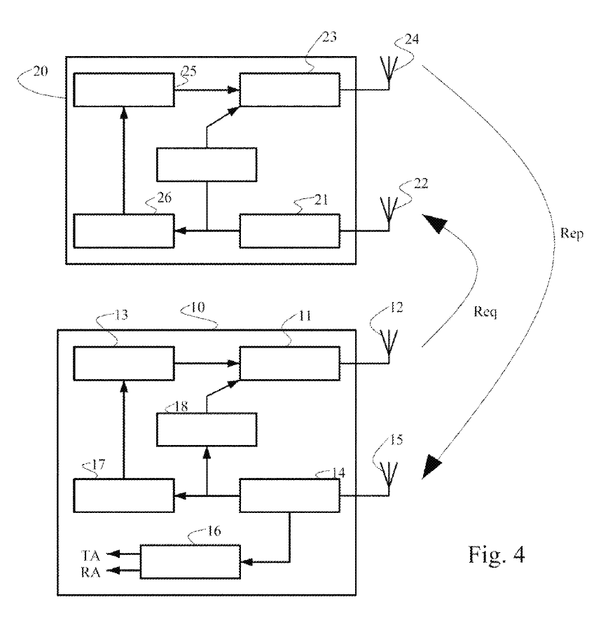

In FIG. 4 there is represented an anti-collision system according to the invention that is an improvement on that represented in FIG. 2. This anti-collision system differs from the latter in that it enables not only control of the transmission power of the response messages Rep transmitted by the transponder 20 as a function of the quality of reception of the radiofrequency signals carrying these messages Rep by the anti-collision apparatus 10, as in the system from FIG. 2, but also the transmission power of the request messages Req by the anti-collision apparatus 10 as a function of the quality of reception by the transponder 20 of the radiofrequency signals carrying these request messages Req.

In this FIG. 4, the elements that have already been described with reference to FIG. 2 carry the same reference and are not described again. Accordingly, relative to the anti-collision system from FIG. 2, the transponder 20 of the anti-collision system from FIG. 4 further includes a unit 26 for measuring the quality Q′ of the radiofrequency signals received via the reception system 21 and delivers data relating to the quality value or values Q′ measured to the encapsulation unit 25 so that these data are encapsulated in the response message Rep to be transmitted via the transmission system 23 to the anti-collision apparatus 10 that transmitted the received message Req.

As for the anti-collision apparatus 10, it further includes a control unit 18 adapted to recover the data relating to the quality value or values Q′ measured by the measurement unit 25 and to control the transmission power Pe of the transmission system 11.

Accordingly, via its transmission system 11, the anti-collision apparatus 10 transmits radiofrequency signals carrying a request message Req to a transponder 20 that receives those radiofrequency signals via its reception system 21 and measures the quality value or values Q′ thereof by means of its measurement unit 26. The or each quality value Q′ measured in this way is encapsulated in the form of data in the response message Rep to the request message Req previously received and that message Rep is transmitted via the transmission system 23 in the form of radiofrequency signals to the anti-collision apparatus 10. The latter receives these radiofrequency signals via its receiver 14 and the control unit 18 decapsulates the data contained in the response message Rep received and extracts therefrom the measured quality value or values Q′ represented by this data. The control unit 18 then controls the transmission system 11.

Accordingly, if the quality value or values measured by the measurement unit 26 represent a low quality, i.e. below one of the quality threshold values Se, the transmission power Pe is increased relative to the preceding transmission, for example by a predetermined incremental value, or a value that is a function of the measured quality value or values or a value that is a function of the difference between the measured value or values and one or more threshold values Se. Conversely, if the quality value or values measured by the measurement unit 26 represent a high quality, i.e., one above one or more quality threshold values Se, the transmission power Pe is reduced relative to the preceding transmission, for example by a predetermined decremental value, or a value that is a function of the measured quality value or values or a value that is a function of the difference between the measured value or values and one or more threshold values.

According to one embodiment, the quality value of the radiofrequency signal measured by the measurement unit 26 is the value of at least one of the following characteristics:

the reception power Pr′ of the radiofrequency signals carrying a request message Req received via the reception system 21,

the signal-to-noise ratio S/N′ of the radiofrequency signal carrying a request message Req received via the reception system 21,

the bit error rate BER′ of the radiofrequency signal carrying a request message Req received via the reception system 21.

According to one embodiment of the invention, the quality Q′ of the radiofrequency signal measured by the measurement unit 26 is the reception power Pr′ of the radiofrequency signals carrying a request message Req received via the reception system 21. Accordingly, if the measured value of the reception power Pr′ is less than a power threshold value Ps′, the transmission power Pe is increased, for example by a predetermined incremental value, a value that is a function of the measured reception power Pr′ or a value that is a function of the difference Pr′−Ps′. Conversely, if the measured value of the reception power Pr′ is greater than a threshold power Ps′, the transmission power Pe is reduced, for example by a predetermined decremental value, or a value that is a function of the measured reception power Pr′ or a value that is a function of the difference Pr′−Ps′.

According to another embodiment of the invention, the quality Q′ of the radiofrequency signal measured by the measurement unit 26 is the signal-to-noise ratio S/N′ of the radiofrequency signal carrying a request message Req received via the reception system 21. Accordingly, if the measured value of the ratio S/N′ is less than a threshold value S/N′, the control signal Sp is such that the transmission power Pe is increased and conversely, if the measured value is greater than the threshold value S/Ns', the control signal Sp is such that the transmission power Pe is reduced.

According to another embodiment of the invention, the quality of the radiofrequency signal measured by the measurement unit 26 is the bit error rate BER' of the radiofrequency signal carrying a request message Req received and decoded by the reception system 21. Accordingly, if the measured value of the bit error rate is less than a threshold value BERs', the control signal Sp is such that the transmission power Pe is reduced and conversely, if the measured value is greater than the threshold value BERs', the control signal Sp is such that the transmission power Pe is increased.

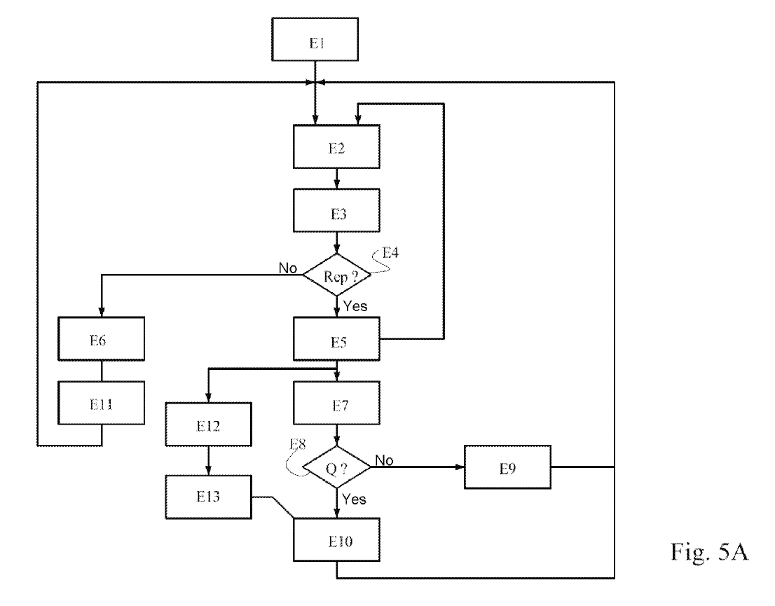

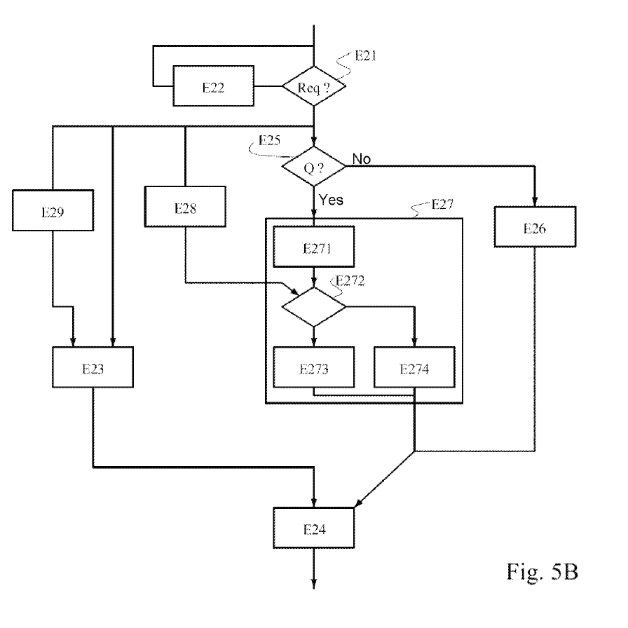

FIG. 5A is a diagram illustrating the steps carried out by an anti-collision apparatus 10 of an aircraft, such as the aircraft 1 from FIG. 1, of a power control method that is implemented by an anti-collision system conforming to that from FIG. 4. The same steps as those that have already been described with reference to FIG. 3A carry the same reference and are not described again.

Of these steps, the step E7 is a step of reading the content of the response message Rep received in the step E4 and the step E8 is a step of verification that the message Rep read in this way contains data relating to the quality of the radiofrequency signals previously received by the transponder 20. If this is not the case, as in the prior art, there is carried out a step E9 of controlling the transmission power Pe of the next request message Req to be transmitted so that:

Pe=Pemax+20 Log (r/10)

r (range) being the distance separating the aircraft 1 equipped with the anti-collision apparatus 10 and the aircraft 2 equipped with the transponder 20. The control step E9 is followed by the step E2 of generating a new request message Req (for example by the generator unit 13) and the transmission step E3 (for example via the transmission system 11) of this message Req in the form of radiofrequency signals. This loop via the control step E9 enables compatibility of the anti-collision system of the invention in the situation where the transponder 20 that has responded to a request message Req conforms to the prior art and therefore does not implement the power control method according to the present invention.

If the message Rep read in the step E7 contains data relating to the quality of the radiofrequency signals received by the transponder 20 measured by its measurement unit 26, there is carried out (for example by the control unit 18 from FIG. 6) a control step E10 to set the transmission power Pe of the radiofrequency signals carrying the request messages Req as a function of the quality value or values encapsulated in the response messages Rep transmitted by the transponder 20.

For example, the control step E10 can comprise comparing the quality value or values Q′ to one or more threshold values Se. Accordingly, if the quality value or values Q′ are less than one or more quality threshold values Se, the transmission power Pe is increased relative to the preceding transmission, for example by a predetermined incremental value, or a value that is a function of the measured value or values of the quality or a value that is a function of the difference between the measured value or values and one or more threshold values. Conversely, if the quality value or values Q′ are greater than one or more quality threshold values Se, the transmission power Pe is decreased relative to the preceding transmission, for example by a predetermined decremental value, or a value that is a function of the measured quality value or values or a value that is a function of the difference between the measured value or values and one or more threshold values.

If in the step E4 no response to a request message Req previously transmitted by the anti-collision apparatus 10 has been received from the transponder 20 (option “no”), for example at the end of a predetermined time, there is carried out, as in the method from FIG. 3A, the step E6 of setting the transmission power Pe to a value greater than the current value, for example to the maximum power Pemax.

There can also be carried out an optional step E11 of adjusting the threshold value Se. In fact it can happen that the current threshold value Se is too low and so the transmission power Pe is too low, which leads to no response to the request messages Req. The adjustment step E11 can solve this problem by increasing the threshold value Se, for example incrementally.

The steps E9 and E11 are followed by the step E2 of generating a new request message Req and a step E3 of transmitting that new message.

The step E12 is a step of determination of aeronautical data, such as:

the time Tau to collision,

the distance r (range) between the aircraft concerned and the intruder aircraft,

the relative speed (Range rate) Rr defined as the variation in time of the distance r, and

the accuracy of the bearing B defined as the angle formed by the direction of the intruder aircraft and the bearing of the aircraft concerned.

The step E13 is a step of modification of the threshold value Se relative to a predetermined threshold value or the current threshold value, on the basis of at least one of the aeronautical data determined in the step E12.

For example, in the situation where the quality of the radiofrequency signals concerned is the power Pr of reception by the transponder 20, the threshold value Se can be reduced if:

the distance r decreases,

the time Tau to collision decreases in time,

the relative speed Rr increases,

the bearing oscillates significantly on the navigation display ND.

The result of decreasing the threshold value Se will be an increase in the power Pe of transmission by the anti-collision apparatus 10.

In contrast, this threshold value Se can be increased if the distance r is greater than a predetermined distance, for example 30 nm. The result of this increase in the threshold value Se will be a decrease in the transmission power Pe.

FIG. 5B is a diagram illustrating the steps carried out by a transponder 20 of an aircraft, such as the aircraft 2 from FIG. 1, of a power control method that is implemented by an anti-collision system conforming to that from FIG. 4. The same steps as those already described with reference to FIGS. 3B and 3Bbis carry the same references and are not described again.

The step E29 is a step of measuring the quality of the radiofrequency signals received in the step E21 the result of which is a quality value or a plurality of quality values Q′ (this step E29 is for example implemented in a measurement unit 26 of a transponder 20 conforming to FIG. 4). This quality value or these quality values Q′ are encapsulated in the form of data in a response message Rep during the generation step.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1-16. (canceled)

17. A method of controlling a transmission power of messages used by a traffic alert and collision avoidance system, said system including an anti-collision apparatus and a transponder equipping each aircraft,
said method including the following steps carried out by said anti-collision apparatus of a first aircraft:
transmitting request messages in the form of radiofrequency signals carrying said messages, and
receiving radiofrequency signals carrying response messages transmitted by said transponder in response to said request messages,
said method further including the following steps carried out by said transponder of a second aircraft:
receiving the radiofrequency signals carrying request messages transmitted by said anti-collision apparatus, and
transmitting the radiofrequency signals carrying response messages in response to request messages,
said method further including the following steps carried out by said anti-collision apparatus of said first aircraft:
measuring at least a value, termed a quality value, of a magnitude representing a quality of reception of the radiofrequency signals carrying response messages transmitted by said transponder and
encapsulating data representing said quality value or values in said request message to be transmitted by said anti-collision apparatus,
said method further including the following steps carried out by said transponder of said second aircraft:
controlling the transmission power of the radiofrequency signals carrying said response messages as a function of the quality value or values encapsulated in the request messages transmitted by said anti-collision apparatus of said first aircraft.

18. The power control method according to claim 17, further including the following steps carried out by said transponder,
measuring at least a value, termed a quality value, of a magnitude representing a quality of reception of the radiofrequency signals carrying request messages transmitted by an anti-collision apparatus, and
encapsulating data representing said measured quality value or values in a response message,
and further including the following steps carried out by said anti-collision apparatus,
setting the transmission power of the radiofrequency signals carrying said request messages as a function of the quality value or values encapsulated in the response messages transmitted by said transponder.

19. The power control method according to claim 18, wherein the quality value of the radiofrequency signal measured in the step of measuring the quality value of the transponder signals or measuring the quality value of the anti-collision apparatus signals is the value of at least one of the following characteristics:
a reception power of the radiofrequency signals carrying a response message received from the transponder,
a signal-to-noise ratio of the radiofrequency signal carrying the response message received from the transponder,
a bit error rate of the radiofrequency signal carrying the response message received from the transponder.

20. The power control method according to claim 17, wherein said control step includes:
comparing the or each quality value to a threshold value,
increasing the transmission power of a next response message to be transmitted if the quality represented by the or each quality value is less than the quality represented by said threshold value, and
reducing the transmission power of a next request message to be transmitted if the quality represented by the or each quality value is greater than the quality of that threshold value.

21. The power control method according to claim 17, including a step of setting the transmission power to a value greater than a current value if the step of receiving the radiofrequency signals carrying request messages transmitted by said anti-collision apparatus does not receive any request message from an anti-collision apparatus during a predetermined time.

22. The power control method according to claim 17, including a step of dynamic adjustment of the threshold value as a function of the value taken by at least one aeronautical parameter.

23. The power control method according to claim 22, wherein said adjustment step dynamically adjusts said threshold value as a function of the nature of the request messages received.

24. The power control method according to claim 22, wherein said adjustment step dynamically adjusts said threshold value upward if a traffic advisory or a resolution advisory has been transmitted by an anti-collision apparatus.

25. The power control method according to claim 22, wherein said adjustment step dynamically adjusts said threshold value upward if the altitude of the aircraft decreases.

26. The power control method according to claim 17, including a step of setting the transmission power of a next response message to be transmitted to a predetermined maximum power, said control step being carried out if the received request message does not contain data relating to the quality value of the radiofrequency signals previously received by said anti-collision apparatus.

27. The power control method according to claim 17, further including a step of determining aeronautical data and a step of modifying the threshold value as a function of the values of said aeronautical data.

28. A method of controlling the transmission power of messages implemented by a transponder of a traffic alert and collision avoidance system of an aircraft to prevent the collision of said aircraft in flight with another aircraft, said method including the following steps:
receiving radiofrequency signals carrying a request message transmitted by an anti-collision apparatus of said other aircraft,
transmitting to said anti-collision apparatus a response message in the form of radiofrequency signals carrying said message,
wherein said method includes a control step of setting the transmission power of the radiofrequency signals carrying said response messages as a function of a quality value or values encapsulated in the request message received from said anti-collision apparatus.

29. The power control method according to claim 28, wherein said control step includes:
comparing the or each quality value to a threshold value,
increasing the transmission power of a next response message to be transmitted if a quality represented by the or each quality value is less than the quality represented by said threshold value, and
reducing the transmission power of a next request message to be transmitted if the quality represented by the or each quality value is greater than the quality of that threshold value.

30. The power control method according to claim 28, including a step of setting the transmission power to a value greater than a current value if the step of receiving the radiofrequency signals carrying request messages transmitted by said anti-collision apparatus does not receive any request message from an anti-collision apparatus during a predetermined time.

31. The power control method according to claim 28, including a step of dynamic adjustment of the threshold value as a function of the value taken by at least one aeronautical parameter.

32. The power control method according to claim 28, including a step of setting the transmission power of the next response message to be transmitted to a predetermined maximum power, said control step being carried out if the received request message does not contain data relating to the quality value of the radiofrequency signals previously received by said anti-collision apparatus.

33. A power control method implemented by an anti-collision apparatus of a traffic alert and collision avoidance system of an aircraft, comprising:
generating a request message,
transmitting in the form of radiofrequency signals the request message resulting from the generating step,
receiving the radiofrequency signals carrying a response message transmitted by a transponder of another aircraft in response to said request message, and
measuring a quality of the radiofrequency signals received from said transponder and carrying the response message,
data representing the quality value or values measured being encapsulated in a new request message generated in a new step of generation of a request message.

34. A traffic alert and collision avoidance system for preventing collision of a first aircraft and a second aircraft, of the type including an anti-collision apparatus equipping said first aircraft and a transponder equipping said second aircraft, said anti-collision apparatus including
a transmission system for transmitting request messages in the form of radiofrequency signals carrying said messages, and
a receiver for receiving radiofrequency signals carrying response messages transmitted by said transponder in response to said request messages,
said transponder including
a reception system for receiving radiofrequency signals carrying request messages transmitted by an anti-collision apparatus, and
a transmitter for transmitting radiofrequency signals carrying response messages in response to request messages,
wherein said transponder includes a measurement unit for measuring at least a value, termed a quality value, of a magnitude representing a quality of reception by the reception system of the radiofrequency signals carrying request messages transmitted by an anti-collision apparatus and an encapsulation unit for encapsulating said quality value or values in said response message, and
wherein said anti-collision apparatus includes a control unit for setting the transmission power of the transmission system as a function of the quality value or values encapsulated in the response messages transmitted by said transponder.

35. The anti-collision apparatus of the system according to claim 34 for preventing collision of a first aircraft and a second aircraft, said anti-collision apparatus including a transmission system for transmitting to a transponder of an intruder aircraft request messages in the form of radiofrequency signals carrying said messages and a receiver for receiving radiofrequency signals carrying response messages transmitted by said transponder in response to said request messages, further including a control unit for setting the transmission power of the transmission system as a function of a quality value or values encapsulated in the response messages transmitted by said transponder.

36. The transponder of the system according to claim 35 for preventing a collision of a first aircraft and a second aircraft, said transponder including a reception system for receiving radiofrequency signals carrying request messages transmitted by an anti-collision apparatus and a transmitter for transmitting radiofrequency signals carrying response messages in response to request messages, further including a measurement unit for measuring at least a value, termed a quality value, of a magnitude representing a quality of reception by the reception system of the radiofrequency signals carrying request messages transmitted by an anti-collision apparatus and an encapsulation unit for encapsulating said quality value or values in said response message.
